(19) United States
(12) Patent Application Publication
(10) Pub. No.: US 2004/0142481 A1
(43) Pub. Date: Jul. 22, 2004

(54) Foam detection/prevention in the context of a purge and trap sample concentrator

(76) Inventor: Thomas M. Hartlein, Lebanon, OH (US)

Correspondence Address: KIRKPATRICK & LOCKHART LLP, 535 SMITHFIELD STREET, PITTSBURGH, PA, 15222, US

(21) Appl. No.: 10/348,035

(22) Filed: Jan. 21, 2003

(51) Int. Cl. G01N 21/00

(52) U.S. Cl. 436/164

(57) ABSTRACT

A purge and trap sample concentrator system is disclosed. The system includes a non-contact foam sensor positioned proximate an outside surface of a sparge vessel. The sensor is configured to detect foam within the sparge vessel. The system also includes a container for holding a defoaming agent, and a fluid communication line connecting the container to the sparge vessel. The system also includes a pump for selectively pumping a quantity of the defoaming agent through the fluid communication path. Finally, the system includes a processor for receiving a signal from the non-contact foam sensor. The signal is indicative of foam within the sparge vessel. The processor is configured to turn the pump on and off based at least in part on the signal.

### FIELD OF THE INVENTION

The present invention relates to purge and trap equipment that supplies samples for analysis. In particular, the present invention relates to foam detection and prevention within purge and trap systems.

### BACKGROUND OF THE INVENTION

Purge and trap equipment has been widely used to extract volatile organic compounds (VOC's) from a solid or a liquid sample matrix for introduction into an analysis system for separation and identification. In many cases, the VOC's are concentrated onto an absorbent trap, followed by thermal desorption into a gas chromatograph. Sample matrices can range from soil, plastics, food, flavor, fragrance, emulsions, and water. Purge and trap sample concentration has evolved as a standardized protocol for analyzing environmental samples (i.e., soil, water, etc.). Additionally, several regulatory agencies including the United States Environmental Protection Agency (USEPA), the United States Department of Energy (USDOE), and the United States Department of Defense (USDOD) have instituted methodologies based upon purge and trap sample concentration.

During operation of a typical purge and trap concentrator, purge gas (commonly helium or nitrogen of high purity) is passed through the bottom of a fritted sparge vessel (also known as a purge chamber or a purge device) before it makes contact with a sample. The frit disburses the gas into finely divided bubbles thereby allowing a large surface area of the sample to be contacted. This process allows the inert gas stream to strip the analytes from the sample matrix and concentrate them on an absorbent trap. The VOC's are then released through a sample pathway to a detection system.

In the event of a foaming sample, the sample pathway may become contaminated or possibly destroyed. This causes system down time, expensive repair costs and/or loss of the particular sample associated with the foam. Given these and other difficulties associated with foam, foaming samples present special challenges for purge and trap concentrator systems.

### SUMMARY OF THE INVENTION

One aspect of the present invention pertains to a purge and trap sample concentrator system. The system includes a non-contact foam sensor positioned proximate an outside surface of a sparge vessel. The sensor is configured to detect foam within the sparge vessel. The system also includes a container for holding a defoaming agent, and a fluid communication line connecting the container to the sparge vessel. The system also includes a pump for selectively pumping a quantity of the defoaming agent through the fluid communication path. Finally, the system includes a processor for receiving a signal from the non-contact foam sensor. The signal is indicative of foam within the sparge vessel. The processor is configured to turn the pump on and off based at least in part on the signal.

Another aspect of the present invention pertains to a sensor for detecting foam in a purge and trap sample concentrator. The sensor includes an optical detecting element configured to mount proximate an outside surface of a sparge vessel. The optical detecting element is further configured to detect foam within the sparge vessel.

Yet another aspect of the present invention pertains to a method of operating a purge and trap sample concentrator. The method comprises utilizing a non-contact sensor to detect foam within a sparge vessel. The method also includes generating a signal based on foam detection, and pumping a defoaming agent out of a container and into the sparge vessel based on the signal.

### BRIEF DESCRIPTION OF THE DRAWINGS

FIG. 1 is a diagramatic view of an automatic analysis system.

FIG. 2 is a schematic illustration of a purge and trap system.

FIG. 3 is schematic illustration of a pump and valve combination associated with the purge and trap system in a first operational state.

FIG. 4 is schematic illustration of a pump and valve combination associated with the purge and trap system in a second operational state.

FIG. 5 is schematic illustration of a pump and valve combination associated with the purge and trap system in a third operational state.

### DETAILED DESCRIPTION OF THE PREFERRED EMBODIMENTS

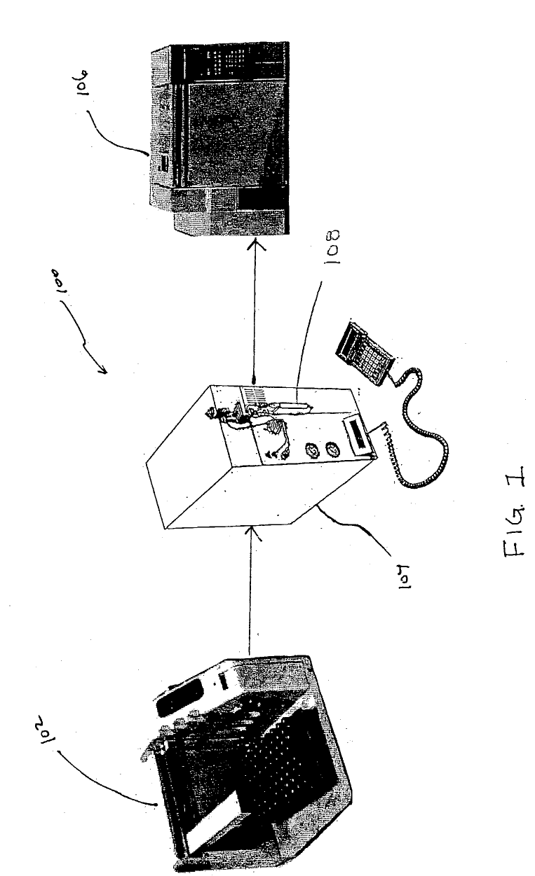

FIG. 1 is a diagramatic view of an automatic analysis system in which embodiments of the present invention are particularly useful. System 100 includes multiple vial autosampler 102, purge and trap sample concentrator 104, and gas chromatograph 106. Autosampler 102 is adapted to receive and maintain a number of vials containing samples. Auto sampler 102 is generally equipped with a robotic system to pick a given vial from its respective position and move it to an analyzation site where a sample is removed from the vial. Generally, the sample is tested for volatile organic components. Examples of auto sampler 102 can be purchased from Tekmar Company of Mason, Ohio under the trade designation SOLATEK 72.

A sample derived from auto sampler 102 is illustratively conveyed to purge and trap concentrator 104. Concentrator 104 then extracts volatile organic compounds from the sample matrix such that they can be provided to gas chromatograph 106. As indicated in FIG. 1, concentrator 104 includes a sparge vessel 108 through which a purge gas is bubbled in order to extract VOC's from the sample matrix. Purge and trap sample concentrators can be obtained from Tekmar Company under the trade designations Model LSC-1, LSC-2, LSC-3, and 3100.

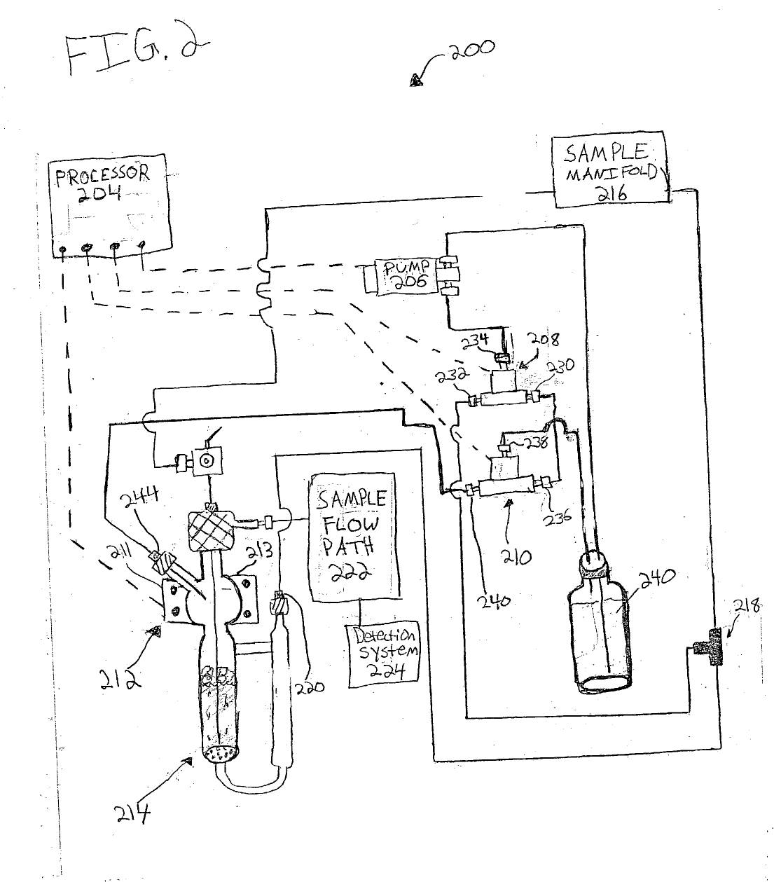

FIG. 2 is a schematic illustration of a purge and trap system 200 in accordance with one aspect of the present invention. System 200 is one example of a system that could be implemented in the context of purge and trap sample concentrator 104 in FIG. 1. Operation of system 200 will be described below in detail.

A significant function associated with system 200 is an ability to detect and compromise a foaming aqueous sample. This function is accomplished through operation of a non-contact sensor that is utilized to detect foam arising from a solution under analysis, and is further accomplished through operation of a pump and valve system that supplies a defoaming agent to destroy or otherwise compromise undesirable foam. After the foam has been destroyed, the non-contact sensor detects the elimination of foam and sends a corresponding signal. In response to the signal, gas is channeled through key system components for the purpose of removing fluids associated with leftover defoaming agents.

Operation of purge and trap system 200 will now be described in greater detail. System 200 includes a processor 204 that is configured to control other components of system 200. Processor 204 is illustratively a computer processing unit. Processor 204 is functionally connected to a pump 206, a first valve 208, a second valve 210, and a sensor 212. Processor 204 receives signals from sensor 212 and, at least partially based on the received signals, controls pump 206, valve 208 and valve 210.

During standard operation of purge and trap system 200, an aqueous sample is placed within a sparge vessel 214 and purged with gas (i.e., helium) to entrain VOC's. The gas is illustratively transferred from a sample manifold 216 through a T-connector 218 into sparge vessel 214 at connection 220. As the sample is purged with gas, VOC's are released through a sample pathway 222 to a detection system 224.

As gas is transferred for purging from sample manifold 216 through T-connector 218, gas is also channeled through T-connector 218 up to a valve 208. Valve 208 has three valve components, namely, valve component 230, valve component 232, and valve component 234. While the sample is being purged within sparge vessel 214, valve component 232 remains closed such that gas is prevented from entering valve 208. Valve component 234 remains open and valve component 230, which is a common valve, always remains open.

Valve 210 includes valve components 236, 238, and 240. Valve component 236 is a common valve and is therefore always open. While the sample is being purged within sparge vessel 214, valve component 238 illustratively remains open, and valve component 240 illustratively remains closed.

Processor 204 is configured to selectively open and shut valve components 234 and 232, as well as valve components 238 and 240. Processor 204 is also configured to turn pump 206 on and off, wherein when pump 206 is on it pumps a defoaming agent 240 from a container and into valve 208 (when component 234 is open).

As was described above, when a sample is being purged within sparge vessel 214, foam that rises from the sample can cause various system failures. In accordance with one aspect of the present invention, sensor system 212 is positioned proximate sparge vessel 214. In accordance with one embodiment, sensor system 212 is positioned proximate a glassware bulb portion of sparge vessel 214.

In accordance with one aspect of the present invention, sensor system 212 is a non-contact sensor designed to detect foam within sparge vessel 214 without making direct contact with the foam (e.g., only a transmitted signal contacts foam). Sensor system 212 illustratively includes an emitter 211 positioned on a first side of a glass portion of vessel 214, and a detector 213 positioned on an opposite side. In accordance with one embodiment, emitter 211 is a light emitter and detector 213 is a corresponding light detector. In accordance with another embodiment, emitter 211 is a sound wave emitter and detector 213 is a sound wave detector. Regardless of the precise nature of the signal being utilized, emitter 211 illustratively transmits a signal through sparge vessel 214 to detector 213. In accordance with one embodiment, an emitter is utilized without a detector (e.g., the emitter monitors its own signal). In accordance with another embodiment, a detector is utilized without an emitter (e.g., presence or absence of ambient light passing through vessel is monitored).

When a sample being purged in vessel 214 begins to foam, the foam will rise up and interrupt the signal being transmitted between emitter 211 and detector 213. For example, rising foam will disperse light being transmitted from emitter 211 and prevent it from reaching detector 213. In instances where there is no detector, the emitter illustratively monitors interruption of its own signal. In accordance with another embodiment, sensor system 212 is an audio-oriented sensor that monitors for the “sound” of foam within sparge vessel 214. Regardless of the precise nature of non-contact sensor system 212, the associated sensing of foam is illustratively managed and monitored by processor 204. Simply for the sake of simplifying description of an embodiment of the present invention, a sensor system 212 is illustrated comprising an optical system having an optical signal transmitted between an emitter and detector will be assumed.

When the signal between emitter 211 and detector 213 is interrupted, processor 204 illustratively executes a series of commands. First, the gas supply from sample manifold 216 is optionally shut off such that gas is no longer supplied through connection 220 to the sample located in sparge vessel 214. Next, valve 210 is toggled such that valve component 238 becomes closed, and valve 240 becomes opened. Then, defoaming agent 240 is pumped by pump 206 through valve component 234, into valve 208, through valve component 230, through valve component 236, into valve 210, through valve component 240, and then through an extension 244 in the upper portion of sparge vessel 214. In this way, defoaming agent is utilized to eliminate foam that has built up in the upper portions of sparge vessel 214.

When the foam has been eliminated, the signal between emitter 211 and detector 213 will be restored. In response to the restoration of the signal, processor 204 turns off-pump 206 and toggles valve 208 such that valve component 234 becomes closed and valve component 232 becomes open. At the same time, valve 210 is toggled such that valve component 240 again becomes closed and valve component 238 again becomes opened.

The gas supply from sample manifold 216 is then turned on such that gas is again supplied to T-connection 218. Given the updated status of valves 208 and 210, gas will now move through valve component 232 and into valve 208. The gas is then channeled through valve component 230, through valve component 236 and into valve 210. The gas then moves through valve component 238 and into the container holding defoaming agent 240. In this manner, valves 208 and 210, as well as associated pumping lines, are swept clean (i.e., swept free of defoaming agent 240).

Next, at the conclusion of a preset time, processor 204 toggles valve 208 to its original configuration wherein valve component 234 is open and valve component 232 is closed. Gas is again channeled from sample manifold 216 through connection 220 and into sparge vessel 214 for normal operation of system 200. In this way, system 200 enables the protection of sample pathways while still enabling the analysis of VOC's in foaming aqueous samples.

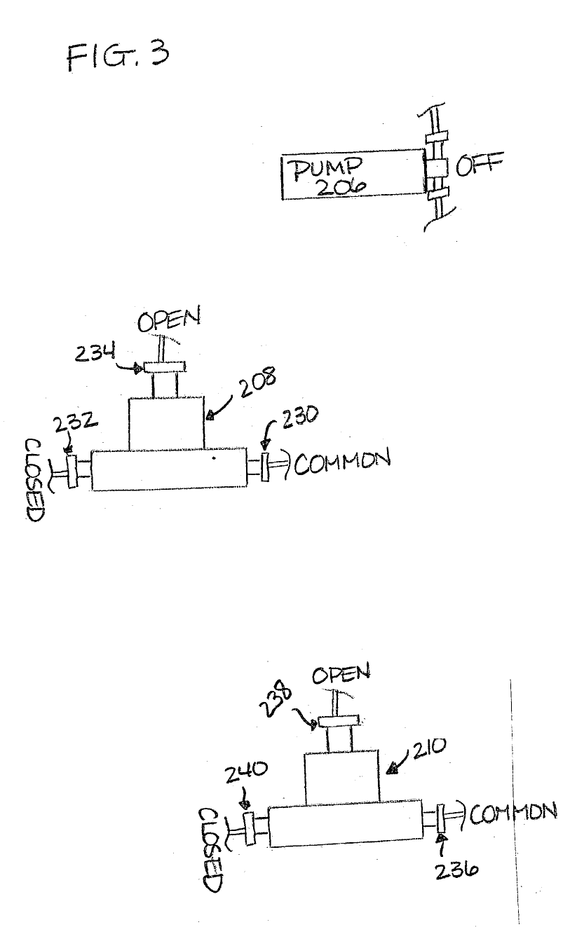

As was described above, during the processes of operation associated with purge and trap system 200, valves 208 and 210 work in association with one another to achieve various operational states. FIG. 3 is a schematic illustration of valve 208, valve 210 and pump 206 in a first operational state, wherein, with reference to FIG. 2, gas is flowing from sample manifold 216, through connection 220, and to sparge vessel 214. In this first operational state, pump 206 is off and therefore does not pump defoaming agent 240 into valve 208 or valve 210. As is illustrated, valve component 232 is closed and therefore prevents gas from flowing from sample manifold 216 through T-connection 218 and into valve 208.

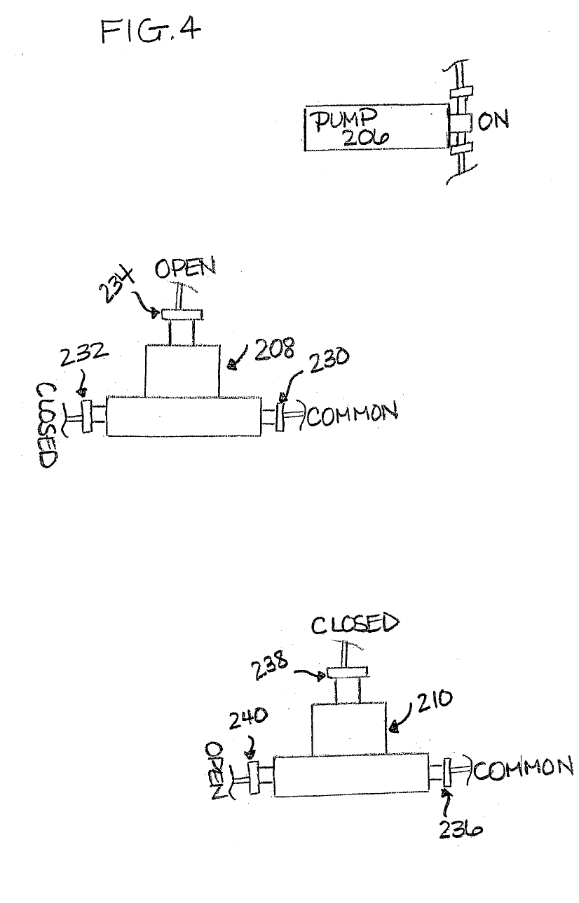

FIG. 4 is a schematic illustration of valve 208, valve 210 and pump 206 in a second operational state that is achieved after foam has been detected by sensor system 212. In the second operational state, valve 210 has been toggled such that valve component 238 has been closed and valve 240 has been opened. During this second operational state, pump 206 is turned on such that defoaming agent 240 is pumped through valve component 234, into valve 208, through valve component 230, through valve component 236, into valve 210, through valve component 240, through connection point 244 and into sparge vessel 214.

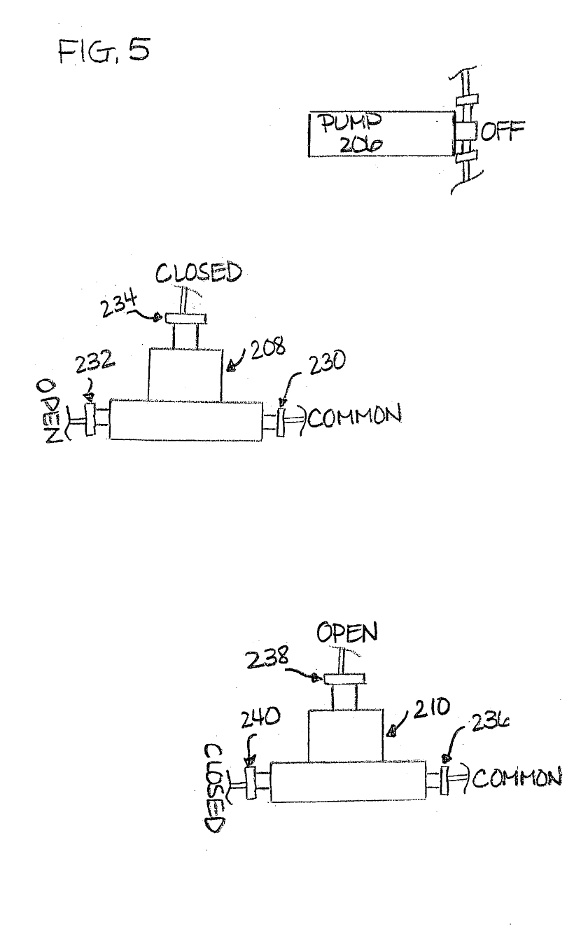

FIG. 5 is a schematic illustration of valve 208, valve 210 and pump 206 in a third operational state, wherein sensor system 212 has now detected that there is no longer foam in sparge vessel 214. In this third operational state, pump 206 is turned off such that defoaming agent 240 is no longer being pumped into valve 208. In addition, valve component 234 of valve 208 is closed to prevent entry of defoaming agent 240. Gas is channeled from sample manifold 216 through valve component 232, into valve 208, through valve component 230, through valve component 236, into valve 210, through valve component 238 and into the container holding defoaming agent 240. In this way, valve 208 and valve 210, as well as associated pumping lines, are swept with gas. After the sweeping process has occurred, processor 204 toggles valve 208 in order to bring system 200 back to the first operational state, as is illustrated in FIG. 3. In this configuration, system 200 accommodates the standard purge and trap sample concentration functionality.

Processor 204 illustratively causes the rotation between operational states to be repeated when sensor system 212 detects foam within sparge vessel 214. Processor 204 receives the detection signals from sensor system 212 and controls pump 206, valve 208 and valve 210 in order to transfer system 200 between the various operational states. The described process protects sample pathways and still allows for the analysis of VOC's in foaming aqueous samples.

Although the present invention has been described with reference to illustrative embodiments, workers skilled in the art will recognize that changes may be made in form and detail without departing from the spirit and scope of the invention.

What is claimed is:

1. A sensor for detecting foam in a purge and trap sample concentrator, the sensor comprising:
an optical detecting element configured to mount proximate an outside surface of a sparge vessel, the optical detecting element being further configured to optically detect foam within the sparge vessel.

2. The sensor of claim 1, wherein the optical detecting element is configured to mount proximate an outside surface of a glass bulb portion of the sparge vessel, the optical detecting element being further configured to detect foam within the glass bulb portion.

3. The sensor of claim 1, wherein the optical detecting element further comprises an emitter device configured to emit an optical signal through a glass portion of the sparge vessel.

4. The sensor of claim 3, wherein the optical detecting element further comprises a detector mounted opposite the emitter and configured to receive the optical signal.

5. The sensor of claim 4, wherein the emitter is positioned on a first side of a glass bulb portion of the sparge vessel, and wherein the detector is positioned opposite the emitter on a second side of the glass bulb portion.

6. A purge and trap sample concentrator system, comprising:
a sparge vessel;
a non-contact foam sensor positioned proximate an outside surface of the sparge vessel, the sensor being configured to detect foam within the sparge vessel;
a container for holding a defoaming agent;
a fluid communication line connecting the container to the sparge vessel;
a pump for selectively pumping a quantity of the defoaming agent through the fluid communication path;
a processor for receiving a signal from the non-contact foam sensor, the signal being indicative of foam within the sparge vessel, the processor being configured to turn the pump on and off based at least in part on the signal.

7. The system of claim 6, wherein the non-contact sensor is an optical detection element.

8. The system of claim 7, wherein the optical detecting element comprises an emitter device configured to emit an optical signal through a glass portion of the sparge vessel.

9. The system of claim 8, further comprising a detector mounted opposite the emitter and configured to receive the optical signal.

10. The system of claim 6, further comprising:
a gas supply manifold;
a gas communication line connecting the container of defoaming agent to the gas supply manifold;
a first valve that is intermediately connected within the fluid communication line and the gas communication line, the first valve being configured to selectively block one or the other of the fluid communication line and the gas communication line.

11. The system of claim 10, further comprising a second gas communication line connecting the sparge vessel to the gas supply manifold.

12. The system of claim 10, further comprising:
a second valve that is intermediately connected within the fluid communication line and the gas communication line, the second valve being configured to selectively block one or the other of the fluid communication line and the gas communication line.

13. The system of claim 12, wherein the processor is configured to control the first and second valves based at least in part on the signal.

14. The system of claim 12, wherein the processor is configured to receive the signal from the non-contact sensor indicating a presence of foam, and is further configured to respond to that signal by adapting the first and second valves to block the gas supply line and open the fluid supply line.

15. The system of claim 14, wherein the processor is further configured to receive a second signal from the non-contact sensor indicating that foam has been eliminated, the processor being further configured to respond to the second signal by adapting the first and second valves to block the fluid supply line and open the gas supply line.

16. The system of claim 15, wherein the processor is further configured to wait a predetermined amount of time after receiving the second signal and then adapt one of the first and second valves to block the fluid supply line, and adapt the other of the first and second valves to block the gas supply line.

17. A method of operating a purge and trap sample concentrator, comprising:
utilizing a non-contact sensor to detect foam within a sparge vessel;
generating a signal based on said foam detection; and
pumping a defoaming agent out of a container and into the sparge vessel based on the signal.

18. The method of claim 17, wherein pumping the defoaming agent comprises pumping the defoaming agent out of the container, through at least one intermediate valve, and into the sparge vessel.

19. The method of claim 18, further comprising:
utilizing the non-contact sensor to monitor when the defoaming agent has substantially eliminated foam; and
generating a second signal that indicates that the defoaming agent has substantially eliminated foam.

20. The method of claim 19, further comprising:
responding to the second signal by manipulating said at least one intermediate valve so as to interupt flow of the defoaming agent and enable a sweeping gas flow at least through said at least one intermediate valve.

21. The method of claim 17, wherein utilizing the non-contact sensor to monitor the presence or absence of foam comprises:
positioning an optical emitter on a first side of a glass portion of a sparge vessel;
positioning an optical detector to receive a signal emitted from the optical emitter;
transmitting an optical signal from the optical emitter to the optical detector; and
monitoring for instances when the optical signal becomes interrupted by foam.

22. The method of claim 21, wherein positioning an optical emitter on a first side of a glass portion of a sparge vessel comprises positioning the optical emitter on a first side of a glass bulb portion of the sparge vessel, and wherein positioning an optical detector on an opposite side of the glass portion of the sparge vessel comprises positioning the optical detector on an opposite side of the glass bulb portion of the sparge vessel.
